(19) United States
(12) Patent Application Publication
(10) Pub. No.: US 2016/0132860 A1
(43) Pub. Date: May 12, 2016

(54) METHOD AND SYSTEM OF PROCESSING PAYMENT USING INSTANT MESSAGE SERVICE

(71) Applicant: LINE BIZPLUS PTE, LTD., International Plaza (SG)

(72) Inventors: Young Su KO, Seongnam-si (KR); Woong Ju JEONG, Seongnam-si (KR); Soo Young KIM, Seongnam-si (KR); Dong Bin OH, Seongnam-si (KR); Sung Sik KANG, Seongnam-si (KR); Eun Hee KIM, Seongnam-si (KR); Seh Wha HONG, Seongnam-si (KR)

(21) Appl. No.: 14/838,882

(22) Filed: Aug. 28, 2015

(30) Foreign Application Priority Data
Nov. 12, 2014 (KR) 10-2014-0157268
Nov. 12, 2014 (KR) 10-2014-0157269

(51) Int. Cl. G06Q 20/32

(52) U.S. Cl. CPC G06Q 20/325

(57) ABSTRACT

Disclosed is a method of processing a payment using an IMS. The method includes obtaining information on a chat room generated through an instant message application between a first user and at least one second user with respect to a payment transaction of the first user, updating a payment account of the first user and a payment account of the at least one second user in response to processing the payment transaction of the first user, and outputting a message associated with the payment transaction of the first user through the chat room.

### CROSS-REFERENCE TO RELATED APPLICATIONS

A claim for priority under 35 U.S.C. §119 is made to Korean Patent Application No. 10-2014-0157268 filed Nov. 12, 2014 and Korean Patent Application No. 10-2014-0157269 filed Nov. 12, 2014, in the Korean Intellectual Property Office, the entire contents of both of which are hereby incorporated by reference.

### BACKGROUND

Example embodiments of inventive concepts described herein relate to payment processing methods and/or systems capable of executing payment processing between users or between users and merchants using an instant message service (hereinafter referred to as “IMS”).

Users may use a variety of payment means for an on-line or off-line transaction. For example, users may purchase desired merchandise online and pay for the merchandise using a credit card or a bank account on a payment platform. Moreover, users may pay for the merchandise using a payment account used on the payment platform instead of a credit card or a bank account.

Users may expand social relationships using the IMS and an IMS provider may combine services, such as game, advertisement, search, online shopping, and digital contents transaction, with an IMS.

For example, payment processing may be executed to combine services, such as game, advertisement, search, online shopping, and digital contents transaction, with an IMS, thereby causing a need for a payment processing system (or a payment platform) compatible with the IMS.

### SUMMARY

Some embodiments of the inventive concepts are related to payment processing methods and/or systems capable of providing a payment platform combined with an IMS, thereby making it possible for users of the IMS to conveniently process a payment transaction.

Other example embodiments of the inventive concepts relate to payment processing methods and/or systems capable of processing a user payment transaction by mapping a payment account into an account of an IMS and using the mapped account of the IMS, thereby improving compatibility between an instant message service and a payment processing service.

Other embodiments of the inventive concepts relate to payment processing methods and/or systems capable of outputting a message associated with processing of a payment transaction using a chat room generated through an instant message application, therefore users may more conveniently identify how the payment transaction is processed.

Other example embodiments of the inventive concepts relate to payment processing methods and systems capable of combining an IMS with a service for processing various payment transactions such as remitting, remittance-requesting, and group-remitting, therefore it may be possible to provide a variety of options on a payment transaction to users of an IMS.

Other example embodiments of the inventive concepts relate to payment processing methods and systems capable of specifying an opponent of a payment transaction through a chat room or a buddy list of an IMS, therefore, it may be possible to expand the convenience of users of an IMS.

The technical objectives of the inventive concepts are not limited to the above disclosure; other objectives may become apparent to those of ordinary skill in the art based on the following descriptions.

Some example embodiments relate to a method of processing a payment using an instant message service (IMS).

In some example embodiments, the method includes obtaining information identifying a chat room associated with an instant message application, the chat room configured to facilitate a payment transaction between a first user and at least one second user; updating a payment account of the first user and a payment account of the at least one second user in response to processing the payment transaction; and outputting a message associated with the payment transaction through the chat room.

In some example embodiments, the method further includes obtaining, from a payment account database, the payment account of the first user and the payment account of the at least one second user in response to executing the payment transaction user, and mapping the payment account of the first user in the payment account database with an account on an IMS server.

In some example embodiments, the updating a payment account includes, transferring funds from the first user to the at least one second user, if the payment transaction is a remitting transaction, requesting the first user to transfer funds to the at least one second user, if the payment transaction is a remittance-requesting transaction, and transferring funds to a third party by a group, if the payment transaction is a group-remitting transaction, the group including the first user and the at least one second user.

In some example embodiments, the method further includes identifying the second user using the information identifying the chat room, when the first user requests processing of the payment transaction in the chat room.

In some example embodiments, the method further includes determining if the chat room between the first user and the at least one second user is established, in response to executing the payment transaction; and generating a new chat room, if the determining determines that the chat room is not established.

In some example embodiments, the chat room includes information associated with an account of the first user, an account of the at least one second user, and a unique identification number of the chat room.

In some example embodiments, the method further includes displaying the message such that the displayed message includes a user edit area, and a fixed format area, the user edit area including at least one of a text, an image, or a video, provided by the first user, and the fixed format area having a format determined based on the processing of the payment transaction.

In some example embodiments, the displaying displays the user edit area and the fixed format area in a bubble.

In some example embodiments, the method further includes receiving a selection, via the chat room, the selection instructing a IMS server to perform one of a remitting transaction to transfer funds from the first user to the at least one second user, a remittance-requesting transaction to request the first user to transfer fund to the at least one second user, and a group-remitting transaction to transfer funds from a group to a third party, the group including the first user and the at least one second user.

In some example embodiments, the method further includes detecting an interaction between the first user and the at least one second user via a message communicated therebetween during processing the payment transaction of the first user; and executing processing of the payment transaction based on the interaction.

In some example embodiments, when the selection instructs the IMS server to perform the remittance-requesting transaction, the method further includes extracting a remittance-requested amount of money included in a remittance request message transmitted from the at least one second user to the first user, and transferring the remittance-requested amount of money from the payment account of the first user to the payment account of the at least one second user based on the remittance request message.

In some example embodiments, the method further includes determining whether the payment account of the first user exists based on the remittance request message transmitted from the at least one second user to the first user.

In some example embodiments, the message includes at least one of a value of funds remaining in the payment account of the first user after the payment transaction, a change in value of the payment account after the payment transaction, and information indicating whether the payment transaction successfully completed.

In some example embodiments, when the selection instructs the IMS server to perform the group-remitting transaction, the method further includes selecting the at least one second user from one or more of a buddy list associated with the first user and participants associated with the chat room; calculating a share of the funds associated with each of the first user and the at least one second user based on a number of users included in the first user and the at least one second user, and processing a payment transaction with respect to the share associated with each of the first user and the at least one second user.

In some example embodiments, the method further includes determining whether the payment transaction is executed by each of the first user and the at least one second user; and outputting a confirmation message indicating whether the payment transaction is executed.

Some example embodiments relate to a method of processing a payment on a payment platform, the payment platform configured to integrate with an instant message service (IMS).

In some example embodiments, the method includes receiving a request through an instant message application, the request associated with processing a payment transaction between a first user and at least one second user using information stored in a server associated with the IMS, the information indicating a relationship between the first user and the at least one second user; extracting a first payment account corresponding to an IMS account of the first user and a second payment account corresponding to an IMS account of the at least one second user; and updating a value registered in the first payment account and the second payment account in response to processing of the payment transaction.

In some example embodiments, the updating includes updating a value registered in the first payment account and the second payment account on the payment platform in response to processing of the payment transaction, the updating being performed without communicating with external financial institutions associated with the first user and the at least one second user.

In some example embodiments, the extracting includes obtaining, from a payment account database included in a payment server associated with the payment platform, the first payment account in response to executing the payment transaction of the first user; and generating a map by mapping an IMS account of the first user and an IMS account of the second user with the first payment account and the second payment account, respectively, and storing the map in the payment account database.

In some example embodiments, the payment transaction includes at least one of a remitting transaction, a remittance-requesting transaction, and a group-remitting transaction, wherein the updating transfers a fund from the first user to the at least one second user, if the payment transaction is the remitting transaction, the updating requests the first user transfer funds to the at least one second user, if the payment transaction is the remittance-requesting transaction, and the updating transfers a fund from a group to a third party, if the payment transaction is the group-remitting transaction, the group including the first user and the at least one second user.

In some example embodiments, when the payment transaction is the remitting transaction, the updating includes decreasing a value registered in the first payment account by an amount corresponding to a fund transmitted to the at least one second user by the first user, and increasing a value registered in the second payment account by the amount.

Some example embodiment of the inventive concepts relate to a payment processing system using an IMS.

In some example embodiments, the payment processing system includes an IMS server configured to provide the IMS, a first user terminal configured to execute an instant message application for providing the IMS and a payment server configured to process a payment transaction of the first user, and the payment server includes a first module configured to obtain information on a chat room generated through the instant message application between the first user and at least one second user on the payment transaction of the first user, a second module configured to update the payment account of the first user and the payment account of the at least one second user in response to processing the first user's payment transaction, and a third module configured to communicate with the IMS server such that a message associated with the payment transaction of the first user is outputted through the chat room.

Some example embodiment of the inventive concepts relate to a computer-readable recording medium storing a command, the command causing a computer to execute a payment processing method using an IMS.

In some example embodiment, the payment processing method includes obtaining information on a chat room generated through an instant message application between a first user and at least one second user with respect to a payment transaction of the first user, updating the payment account of the first user and the payment account of the at least one second user in response to processing the payment transaction of the first user, and outputting a message associated with the payment transaction of the first user through the chat room.

### BRIEF DESCRIPTION OF THE FIGURES

The above and other objects and features will become apparent from the following description with reference to the following figures, wherein like reference numerals refer to like parts throughout the various figures unless otherwise specified, and wherein

FIG. 1 is a diagram illustrating a payment processing system including an instant message service (hereinafter referred to as “IMS) server, a payment server, and a plurality of user terminals and using an IMS, according to an example embodiment of the inventive concepts;

FIG. 2 is a diagram illustrating an online/offline transaction system including user terminals having a function for processing a payment, according to an example embodiment of the inventive concepts;

FIG. 3A is a diagram illustrating a relation between accounts of an IMS stored in buddy relation database of an IMS server and payment accounts stored in payment account database of a payment server;

FIG. 3B is a diagram conceptually illustrating a value transfer executed in payment account database when a user X shown in FIG. 3A executes a payment transaction on a user A which is a buddy of the user X;

FIG. 4 is a data structure illustrating a payment account, in which an IMS account is mapped into a user X, and detailed information;

FIG. 5A is a diagram illustrating a method of a payment processing using an IMS according to an example embodiment of the inventive concepts;

FIG. 5B is an flow chart illustrating a method of a payment processing using an IMS according to an example embodiment of the inventive concepts;

FIG. 6 illustrates screens of a user terminal when a payment account is registered, according to an example embodiment of the inventive concepts;

FIG. 7 illustrates screens of a user terminal when a payment transaction on remitting is executed, according to an example embodiment of the inventive concepts;

FIG. 8 illustrates screens of a user terminal when a payment transaction on remittance-requesting is executed, according to an example embodiment of the inventive concepts;

FIG. 9 illustrates screens of a user terminal when a payment transaction on a group-remitting is executed, according to an example embodiment of the inventive concepts;

FIG. 10 illustrates screens of a user terminal after a payment transaction is completed, according to an example embodiment of the inventive concepts; and

FIG. 11 is a block diagram schematically illustrating a computing device including a user terminal, an IMS server, or a payment server according to an example embodiment of the inventive concepts.

### DETAILED DESCRIPTION

Example embodiments will now be described more fully hereinafter with reference to the accompanying drawings, in which some example embodiments are shown. The advantages and features of the example embodiments and methods of achieving them will be apparent from the following example embodiments that will be described in more detail with reference to the accompanying drawings. It should be noted, however, that the inventive concepts are not limited to the following example embodiments, and may be implemented in various forms. Accordingly, the example embodiments are provided only to disclose the inventive concepts and let those skilled in the art know the category of the inventive concepts. In the drawings, example embodiments of the inventive concepts are not limited to the specific examples provided herein and are exaggerated for clarity.

The terminology used herein is for the purpose of describing example embodiments only and is not intended to limit example embodiments. As used herein, the singular terms “a,” “an” and “the” are intended to include the plural forms as well, unless the context clearly indicates otherwise. As used herein, the term “and/or” includes any and all combinations of one or more of the associated listed items. It will be understood that when an element is referred to as being “connected” or “coupled” to another element, it may be directly connected or coupled to the other element or intervening elements may be present.

Similarly, it will be understood that when an element such as a layer, region or substrate is referred to as being “on” another element, it can be directly on the other element or intervening elements may be present. In contrast, the term “directly” means that there are no intervening elements. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

Additionally, example embodiments in the detailed description will be described with sectional views as example views of the inventive concepts. Accordingly, shapes of the example views may be modified according to manufacturing techniques and/or allowable errors. Therefore, example embodiments of the inventive concepts are not limited to the specific shape illustrated in the example views, but may include other shapes that may be created according to manufacturing processes. Areas exemplified in the drawings have general properties, and are used to illustrate specific shapes of elements. Thus, this should not be construed as limited to the scope of the inventive concepts.

It will be also understood that although the terms first, second, third etc. may be used herein to describe various elements, these elements should not be limited by these terms. These terms are only used to distinguish one element from another element. Thus, a first element in some example embodiments could be termed a second element in other example embodiments without departing from the teachings of the example embodiments. Example embodiments explained and illustrated herein include their complementary counterparts. The same reference numerals or the same reference designators denote the same elements throughout the specification.

Moreover, example embodiments are described herein with reference to cross-sectional illustrations and/or plane illustrations that are idealized example illustrations. Accordingly, variations from the shapes of the illustrations as a result, for example, of manufacturing techniques and/or tolerances, are to be expected. Thus, example embodiments should not be construed as limited to the shapes of regions illustrated herein but are to include deviations in shapes that result, for example, from manufacturing. For example, an etching region illustrated as a rectangle will, typically, have rounded or curved features. Thus, the regions illustrated in the figures are schematic in nature and their shapes are not intended to illustrate the actual shape of a region of a device and are not intended to limit the scope of example embodiments.

As appreciated, devices and methods of forming devices according to various example embodiments described herein may be embodied in microelectronic devices such as integrated circuits, wherein a plurality of devices according to various example embodiments described herein are integrated in the same microelectronic device. Accordingly, the cross-sectional view(s) illustrated herein may be replicated in two different directions, which need not be orthogonal, in the microelectronic device. Thus, a plan view of the microelectronic device that embodies devices according to various example embodiments described herein may include a plurality of the devices in an array and/or in a two-dimensional pattern that is based on the functionality of the microelectronic device.

The devices according to various example embodiments described herein may be interspersed among other devices depending on the functionality of the microelectronic device. Moreover, microelectronic devices according to various example embodiments described herein may be replicated in a third direction that may be orthogonal to the two different directions, to provide three-dimensional integrated circuits.

Accordingly, the cross-sectional view(s) illustrated herein provide support for a plurality of devices according to various example embodiments described herein that extend along two different directions in a plan view and/or in three different directions in a perspective view. For example, when a single active region is illustrated in a cross-sectional view of a device/structure, the device/structure may include a plurality of active regions and transistor structures (or memory cell structures, gate structures, etc., as appropriate to the case) thereon, as would be illustrated by a plan view of the device/structure.

Example embodiments disclosed herein may include hardware configured to execute program code including program instructions, software components, software modules, data files, data structures, and/or the like. Examples of program code include both machine code produced by a compiler and higher level program code that is executed using an interpreter. The hardware devices may include one or more processors. The one or more processors are computer processing devices configured to carry out the program code by performing arithmetical, logical, and input/output operations. Once the program code is loaded into the one or more processors, the one or more processors may be programmed to perform the program code, thereby transforming the one or more processors into special purpose processor(s).

Alternatively, or in addition to the processors discussed above, the hardware devices may include one or more Central Processing Units (CPUs), digital signal processors (DSPs), application-specific-integrated-circuits (ASICs), SoCs, field programmable gate arrays (FPGAs), or the like. In at least some cases, the one or more CPUs, SoCs, DSPs, ASICs and FPGAs, may generally be referred to as processing circuits and/or microprocessors. The hardware devices may be configured as special purpose processing circuits and/or hardware devices to perform functions illustrated in one or more of the flow charts or sequence diagrams discussed herein.

The hardware devices may also include one or more storage devices. The one or more storage devices may be tangible or non-transitory computer-readable storage media, such as random access memory (RAM), read only memory (ROM), a permanent mass storage device (such as a disk drive), and/or any other like data storage mechanism capable of storing and recording data. The one or more storage devices may be configured to store program code for one or more operating systems and/or the program code for implementing the example embodiments described herein. The program code may also be loaded from a separate computer readable storage medium into the one or more storage devices and/or the one or more processors using a drive mechanism. Such separate computer readable storage medium may include a USB flash drive, memory stick, Blu-ray/DVD/CD-ROM drive, memory card, and/or other like computer readable storage medium (not shown). The program code may be loaded into the one or more storage devices and/or the one or more processors from a remote data storage device via a network interface, rather than via a computer readable storage medium. Additionally, the program code may be loaded into the one or more storage devices and/or the one or more processors from a remote computing system that is configured to transfer and/or distribute the program code over a network. The remote computing system may transfer and/or distribute the program code via a wired interface, an air interface, and/or any other like tangible or intangible medium. The one or more processors, the one or more storage devices, and/or the program code may be specially designed and constructed for the purposes of the example embodiments, or they may be known devices that are altered and/or modified for the purposes of the example embodiments.

It will be apparent to those skilled in the art that various modifications and variations can be made to the example embodiments without departing from the spirit or scope of the inventive concepts described herein. Thus, it is intended that the example embodiments cover the modifications and variations of the example embodiments provided they come within the scope of the appended claims and their equivalents.

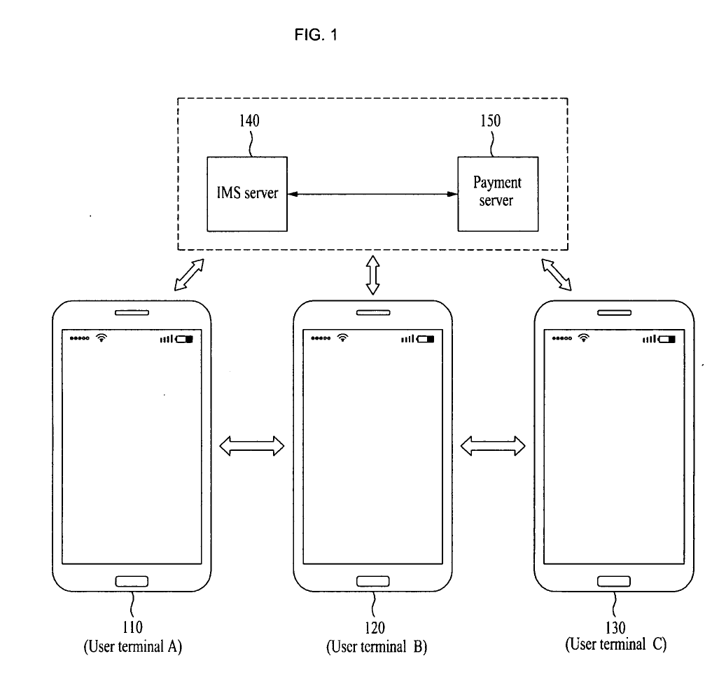

FIG. 1 is a diagram illustrating a payment processing system including an instant message service (hereinafter referred to as “IMS) server, a payment server, and a plurality of user terminals and using an IMS, according to an example embodiment of the inventive concepts.

Referring to FIG. 1, a payment processing system using an IMS may include a plurality of user terminals 110, 120, and 130, an IMS server 140, and a payment server 150.

In some example embodiments, the IMS server 140 and the payment server 150 may each include a processor and a memory (not shown). In other example embodiments, the IMS server 140 and the payment server 150 may share a same processor and memory (not shown).

The memory may be a non-transitory computer-readable storage media configured to store program code that, when executed by the processor, configures the processor as a special purpose computer to quickly transfer funds between users via an instant messaging service (IMS), without requiring direct communication between the financial institutions associated with the users. Therefore, the payment system may improve the functioning of the IMS server 140 and/or the payment server 150 themselves by facilitating the quick transfer of funds between users without requiring the users to have knowledge of their own financial accounts or the financial accounts of each other.

The plurality of user terminals 110, 120, and 130 may include a mobile computing device such as a smart phone and a tablet PC or a personal computer (hereinafter referred to as “PC”).

An instant messenger application may be installed in each of the plurality of user terminals 110, 120, and 130 and each of the plurality of user terminals 110, 120, and 130 may communicate with the IMS server 140. Users may form social relationships using the instant messenger application and may transmit and receive instant messages in real time. Here, the social relationship may denote a buddy list of each of the users and each of the user terminals 110, 120, and 130 may communicate with the IMS server 140 to perform synchronization on information associated with the buddy list and a chat room.

Users may receive an IMS and at the same time, the users may utilize a payment function combined with the instant messenger application to process a variety of payments. For example, users may desire payment processing on digital contents and payment processing in an off-line store while receiving an IMS.

Furthermore, users may transfer a fund to an opponent included in a buddy list formed through an IMS and may request the opponent to transfer a fund. As will be described later, a payment transaction of the users may frequently occur at various situations and example embodiments of the inventive concepts may support at least three payment transactions. For example, the at least three payment transactions may include: (1) a remitting transaction for transferring a fund to an opponent by a user; (2) a remittance-requesting transaction for requesting a fund transfer to a user by an opponent; and (3) a group-remitting transaction for transferring a fund to a third party by a group including a user and at least one opponent.

Moreover, users may be provided with an IMS and at the same time, an account on the IMS and a payment account may be mapped with each other for the users to process various payments. That is, the IMS server 140 may store the account on an IMS of each of users and the payment server 150 may store a payment account of each of the users. Here, the account on the IMS and the payment account may be held as being mapped each other.

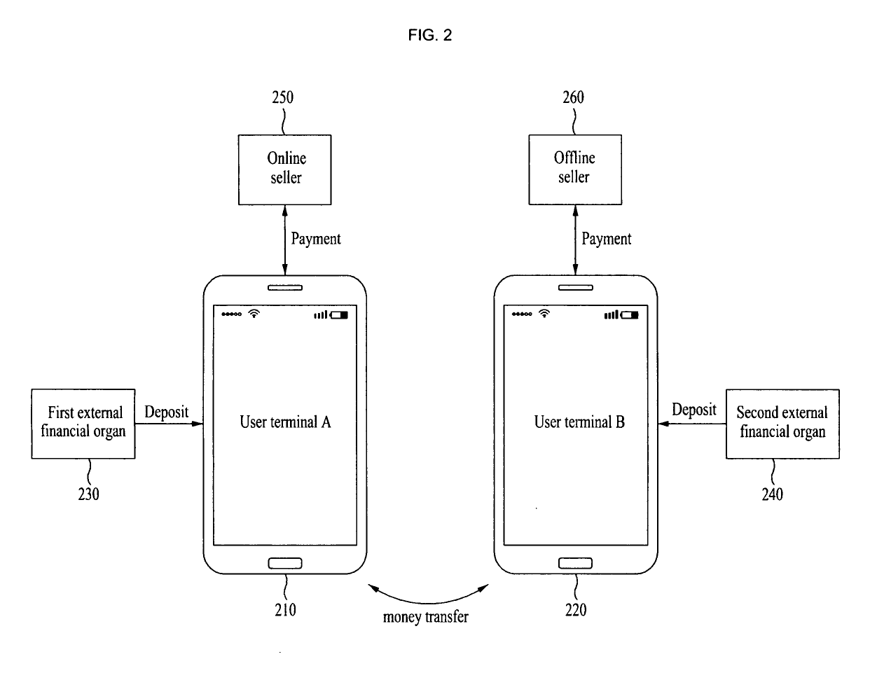

FIG. 2 is a diagram illustrating an online/offline transaction system including user terminals having a function for processing a payment, according to an example embodiment of the inventive concepts.

Referring to FIG. 2, a user terminal A 210 may execute a payment transaction with a user terminal B 220 included in a buddy list of an IMS. For example, the user terminal A 210 may transfer a desired money amount within a value registered in his/her payment account. Here, a portion or all of the registered value in the payment account of the user terminal A 210 may be transferred to the user terminal B 220 regardless of a first external financial institution 230 or a second external financial institution 240. That is, a payment system (including an IMS server 140 and a payment server 150 illustrated in FIG. 1) may update a payment account of the user terminal B 220, in response to transferring a portion or all of the registered value in the payment account of the user terminal A 210 to the user terminal B 220. Even though the user terminal B 220 exchanges the transferred value from the user terminal A 210 into real money, interaction between the first external financial institution 230 and the second external financial institution 240 may not occur. For example, like the user terminal B 220, the payment system may have a bank account in the same second external financial institution 240 in which a bank account of the user terminal B 220 is registered. When the user terminal B 220 exchanges the value transferred from the user terminal A 210 into real money, the real money may be transferred from a bank account of the payment system to a bank account of the user terminal B 220. According to the above-described process, even though no direct interaction exists between the first external financial institution 230 and the second external financial institution 240, the value transferred from the user terminal A 210 to the user terminal B 220 may be provided to the user terminal B 220 as real money.

Furthermore, the user terminal B 220 may request the user terminal A 210 to transfer a desired money amount. The user terminal A 210 and the user terminal B 220 may deposit a fund to increase a value registered in a payment account through the external financial institutions 230 and 240 and exchange the value registered in a payment account into real money through the external financial institutions 230 and 240.

Moreover, the user terminal A 210 and the user terminal B 220 may execute a payment procedure using a payment account with respect to an online seller 250 and an offline seller 260. Here, the payment account may be connected to a credit card and/or a bank account registered by the user terminal A 210 and the user terminal B 220. When a payment is completed, a settlement procedure may be performed through the external financial institutions 230 and 240.

Further, as described above, the user terminal A 210 and the user terminal B 220 may execute payment transactions, such as remitting, remittance-requesting, and group-remitting, within a range to be politically permitted or a value registered by a payment account. Here, regardless of the external financial institutions 230 and 240, a value may be transferred among user terminals having a payment account on a payment platform including a payment server. For example, when the user terminal A 210 transfers 1 dollar registered in a payment account to the user terminal B 220, a value of 1 dollar may be directly transferred from a pay account of the user terminal A 210 to a pay account of the user terminal B 220, instead of transferring a fund from the first external financial institution 230 of the user terminal A 210 to the second external financial institution 240 of the user terminal B 220.

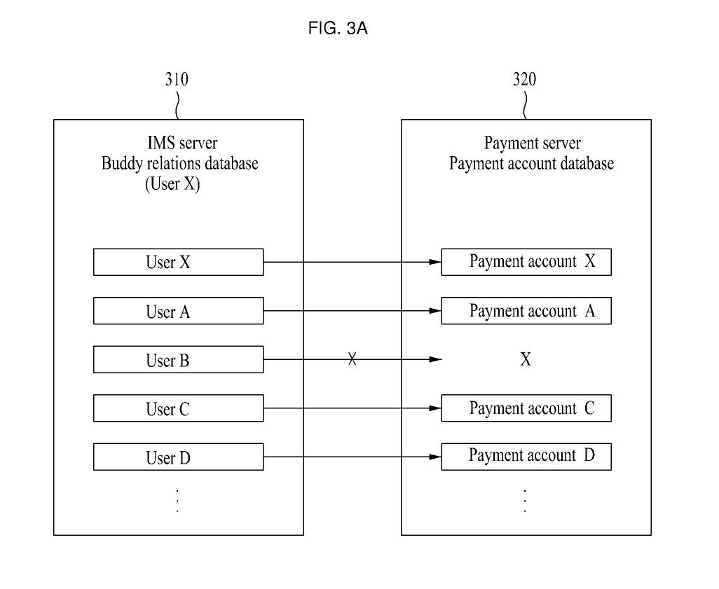

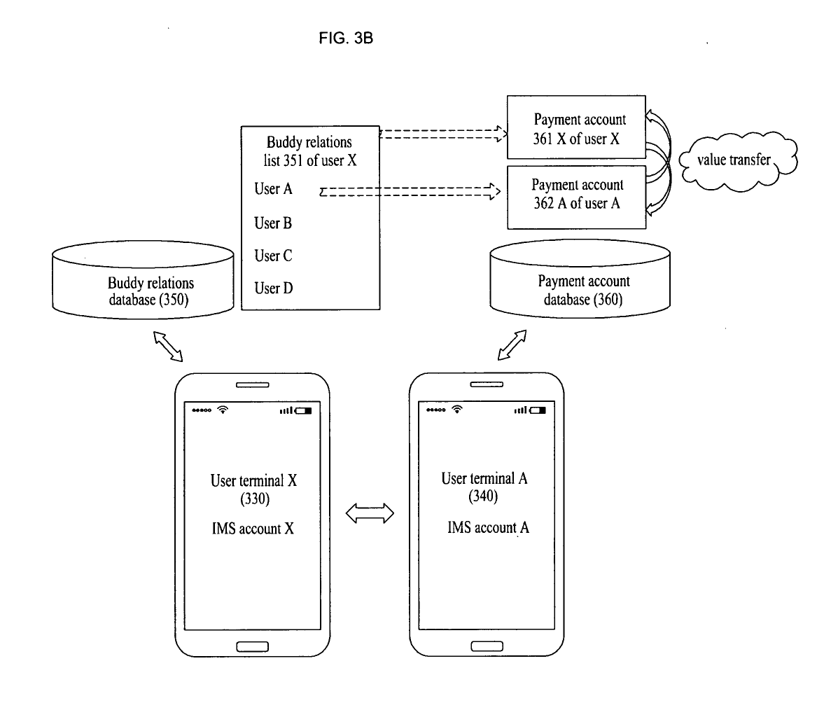

FIG. 3A is a diagram illustrating a relation between accounts of an IMS stored in buddy relation database of an IMS server and payment accounts stored in payment account database of a payment server.

Referring to FIG. 3A, the buddy relation database of the IMS server 140 may store IMS accounts (e.g., a user X and users A, B, C, and D) of users of an IMS. For example, the buddy relation database may store IMS accounts of users A, B, C, and D forming a buddy relation with a user X.

Moreover, the payment account database of the payment server may store a payment account of users which utilize a payment function through the IMS. For example, the payment account database may store a payment account X of the user X, a payment account A of the user A, a payment account C of the user C, and a payment account D of the user D. Here, because the user B does not use a payment function, a payment account of a user B may not exist in the payment account database.

Here, each of payment accounts may be mapped into one of IMS accounts stored in the buddy relation database. According to an example embodiment of the inventive concepts, in the case of selecting at least one opponent from a buddy list or a chat room of an IMS, a specific user may execute a desired payment transaction, even if the user does not know a payment account of at least one selected opponent.

FIG. 3B is a diagram conceptually illustrating a value transfer executed in payment account database when a user X shown in FIG. 3A executes a payment transaction on a user A which is a buddy of the user X.

Referring to FIG. 3B, a user X of a user terminal X 330 and a user A of a user terminal A 340 may have a buddy relation on an IMS. That is, an IMS account X of a user X and IMS accounts of users which have buddy relations may be stored and managed as a buddy relation list 351 in a buddy relation databased 350. Here, the payment account database 360 may store and manage a payment account X 361 corresponding to an IMS account X of the user X and a payment account A 362 of the user A.

When the user X executes a payment transaction with respect to the user A, since user A and user X have a buddy relation, a value may be transferred between the payment account X 361 of the user X and the payment account A 362 of the user A. For example, when the user X transmits a value of 1 dollar to the user A, the value of 1 dollar may be transferred from the payment account X 361 of the user X to the payment account 362 of the user A.

Here, it may be not required for the user X and the user A to know details on each other's payment accounts. Further, the payment transaction may be executed without displaying confidential details on the payment account X 361 of the user X and the payment account A 362 of the user A. In other words, although the user X does not know the payment account 362 of the user A, the aforementioned payment transaction may be successfully executed. The user X and the user A may have a buddy relation on an IMS, and a payment server (not shown) including a payment account database 360 may extract the payment account X 361 mapped into the IMS account X of the user X and the payment account A 362 mapped into the IMS account A of the user A and may transfer a value between the extracted payment account X 361 and a payment account A 362.

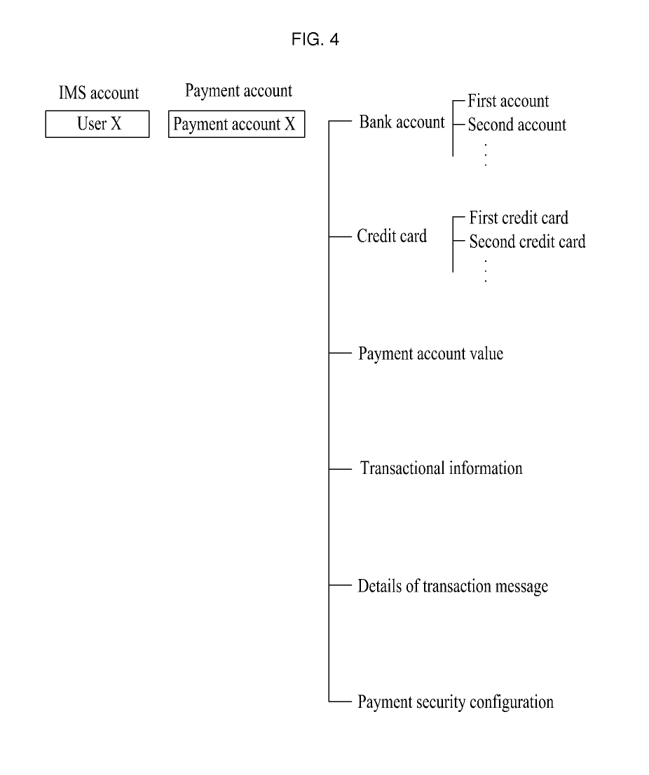

FIG. 4 is a data structure illustrating a payment account, in which an IMS account is mapped into a user X, and detailed information.

Referring to FIG. 4, a “payment account X” may be mapped to a “user X” of an IMS account. The payment account database may store a variety of information on a payment account X. For example, the payment account database may store information on a plurality of bank accounts and information on a plurality of credit cards, which are connected to the payment account X. The user X may increase a value of the payment account using at least one of bank accounts or credit cards and may convert a value registered in the payment account into real money. Here, a value of virtual money registered in the payment account may be used as the same unit as real money.

Furthermore, the payment account database may store details on various payment transactions executed using the payment account X and may store details of transaction messages generated in a process for executing a payment transaction.

Furthermore, the payment account X may be securely protected by security elements set by the user X. For example, the security elements set by the user X may include a password, a security pattern drawn by a user, a user's fingerprint, bio-information such as a face, an iris, and a voice, and a security device independent of a user terminal.

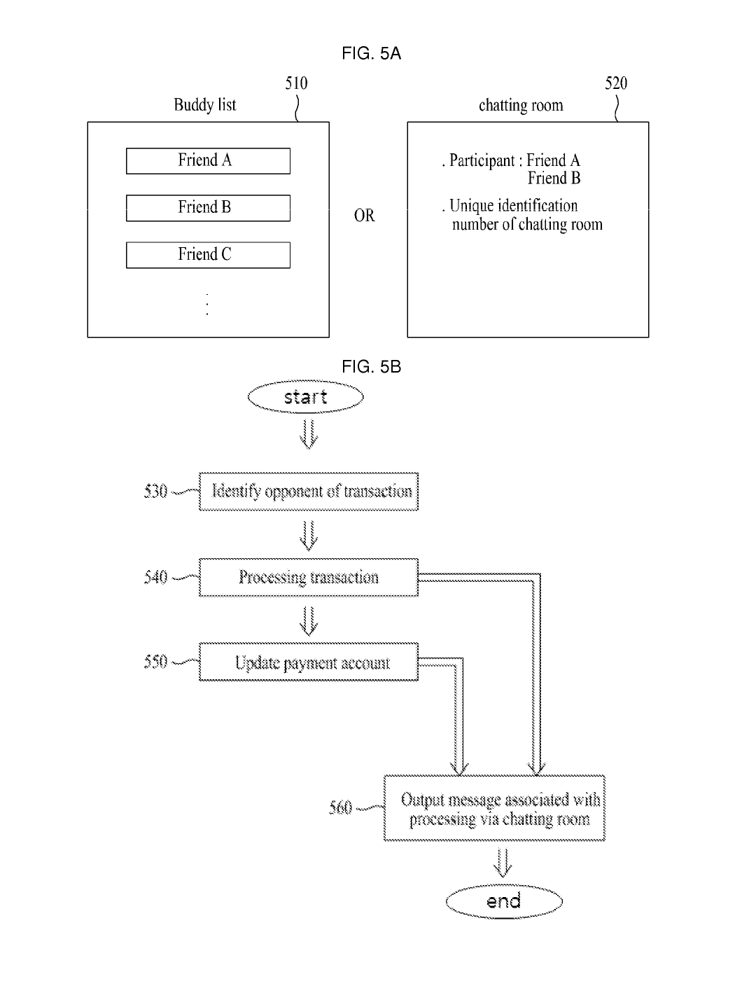

FIGS. 5A and 5B illustrate a method of a payment processing using an IMS according to an example embodiment of the inventive concepts.

FIG. 5A is a diagram illustrating the method of the payment processing using the IMS according to an example embodiment of the inventive concepts.

Referring to FIG. 5A, a user may form social relationships with friends A, B, and C included in a buddy list 510 of an instant message application and may transmit and receive instant messages to and/or from friends A and B in a chat room 520 generated via the instant message application. The chat room 520 may have a unique identification number, and the unique identification number of the chat room 520 and information on participants participating in the chat room 520 may be stored in the IMS server 140.

FIG. 5B is a flow chart illustrating the method of the payment processing using the IMS according to an example embodiment of the inventive concepts.

Referring to FIG. 5B, in operation 530, a user may identify at least one opponent to conduct a payment transaction with via a buddy list 510 and the chat room 520 of an instant message application. When there is already a chat room between a user and at least one opponent, the IMS server 140 or the payment server 150 may identify an IMS account and a payment account of each of the user and the opponent from information on the chat room 520. On the contrary, when there is not a chat room between the user and the opponent, the chat room 520 may be generated by the IMS server 140, and the IMS server 140 or the payment server 150 may identify an IMS account and a payment account of each of the user and the opponent from information on the newly generated chat room 520.

In operation 540, the user may execute at least one of various payment transactions and the payment server 150 may process a payment transaction required by the user. As discussed below, the payment transaction may include: (1) a remitting transaction for transferring funds from the user to the opponent, (2) a remittance-requesting transaction for requesting the opponent transfer funds to the user, or (3) a group-remitting transaction for transferring funds from a group to a third party, where the group may include the user and at least one opponent. However, example embodiments are not limited thereto.

### Remitting Transaction for Transferring Funds to an Opponent by a User

A user may transfer a fund to at least one opponent identified from the chat room 520 or the buddy list 510 within a value registered in a user's payment account. The funds may be transferred among user terminals on a payment platform including a payment server 150, regardless of an external financial institution. For example, when a user transfers 1 dollar registered in a payment account to an opponent, a fund may be directly transferred from the user payment account to the opponent payment account, instead of transferring the fund from the external financial institution of the user to the external financial institution of the opponent.

For example, it may be assumed that 1 dollar of a value registered in a payment account of a user A is transferred to a user B. Here, the payment system may have a bank account in the same financial institution as an external financial institution (e.g., a bank), in which the user B is registered. When the user B exchanges a value transferred from the user A into real money, the real money may be transferred from the bank account of the payment system to the bank account of the user B. The payment system according to an example embodiment of the inventive concepts may have a bank account in the same financial institution as an external financial institution (e.g., a bank), in which a bank account of the user B is registered, and transferring a fund in the same external financial institution may have a very short time delay or may not nearly generate a time delay. Therefore, according to an example embodiment of the inventive concepts, after transferring a value from the user A, the user B may exchange the rapidly transferred value into real money without a time delay. Although there is not a direct interaction between a bank of the user A and a bank of the user B, the value transferred from the user A to the user B may be rapidly transferred to the user B as real money through this process.

For example, it may be assumed that the user A has an account of X bank, the user B has an account of Y bank, and a payment system has an account of the X bank and an account of the Y bank. Here, the payment system may select an account of the same Y bank, as the user B, from among an account of X bank and an account of Y bank. The payment system may transfer a fund corresponding to a value, which is transferred from a payment account of the user A to a payment account of the user B, to an account of a Y bank, which the user B has, using an account of the selected Y bank. Moreover, the user B may exchange the fund corresponding to a value, which is transferred from a payment account of the user A to a payment account of the user B, into real money through an account of the Y bank. Here, because both the payment system and the user B have accounts of the Y bank, the user B may rapidly receive the fund from the payment system.

### Remittance-Requesting Transaction for Requesting User to Transfer a Fund by Opponent

An opponent may request a user to transfer funds. For example, the opponent may request the user transfer funds to the opponent so that the opponent may buy a specific product or digital content. The user may approve the request, thereby, transferring funds to the opponent, thereby making it possible to easily aid the opponent. Likewise, regardless of an external financial institution, a fund may be transferred on a payment platform including a payment server.

### Group-Remitting Transaction for Transferring Fund to Third Party by Group Including at Least One Opponent and User

According to an example embodiment of the inventive concepts, a group including a user and at least one opponent may transfer a fund to the third party. Here, the third party may be a member of the group or may not be a member of the group.

For example, users A, B, and C may split a 30 dollar expense by each of the users A, B, and C contributing 10 dollars (i.e., 30/3) toward the expense. According to an example embodiment of the inventive concepts, each of the users A, B, and C may execute a payment transaction through a payment account using a chat room. Furthermore, when the user A pays the whole meal expense, each of the users B and C may transfer 10 dollars to a pay account of the user A.

In operation 550, when the pay transaction is processed, a user account and a payment account of at least one opponent may be updated in response to processing a payment transaction.

For example, when the user A transfers a fund of 1 dollar to a payment account of the user B, a value registered in a payment account of the user A may decrease as much as 1 dollar and a value registered in a payment account of the user B may increase as much as 1 dollar. Moreover, if a commission occurs upon processing a payment transaction, a value corresponding to the commission may be deducted from a payment account of the user A or a payment account of the user B.

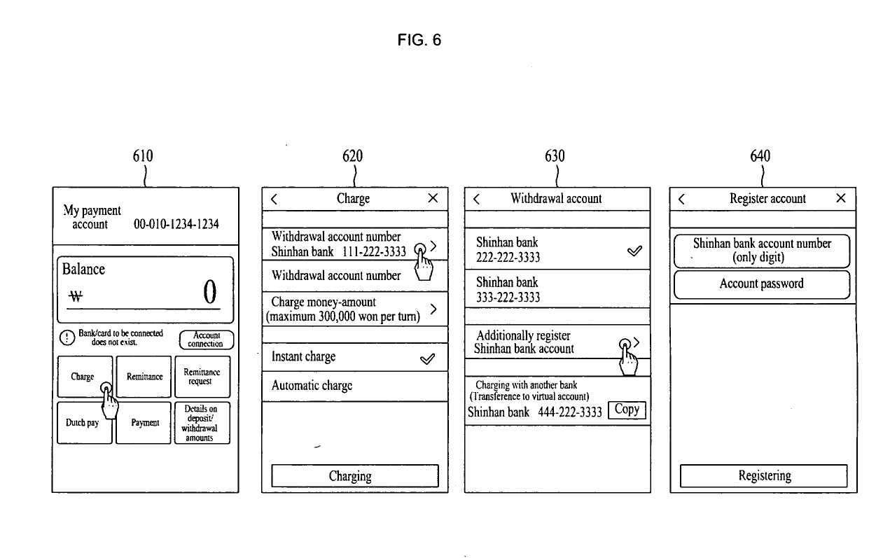

In operation 560, a start of a payment transaction, processing of a payment transaction, and a processing result of a payment transaction (i.e., update of a payment transaction) may be output in the format of instant message through a chat room, which will be described with reference to FIGS. 6 to 9.

FIG. 6 illustrates screens of a user terminal when a payment account is registered, according to an example embodiment of the inventive concepts.

Referring to FIG. 6, as illustrated on screenshots 610-640, the payment system may register a new payment account therein in response to input provided by a user via screens 610-640.

For example, as illustrated in screen 610, a user may inquire for a value registered in a payment account using an instant messenger application. The payment account of the user may be “00-010-1234-1234” and the value registered in a current payment account may be 0 won. When the user selects a “charge” button of the screen 610, the screen 620 may be displayed through an instant messenger application.

As illustrated in the screens 620 and 630, a user may charge a value registered in the payment account using a bank account connected to the payment account, where the bank account is selected from one of a plurality of bank accounts illustrated in screen 630.

As illustrated in the screen 640, a user may additionally register a new bank account with the payment system.

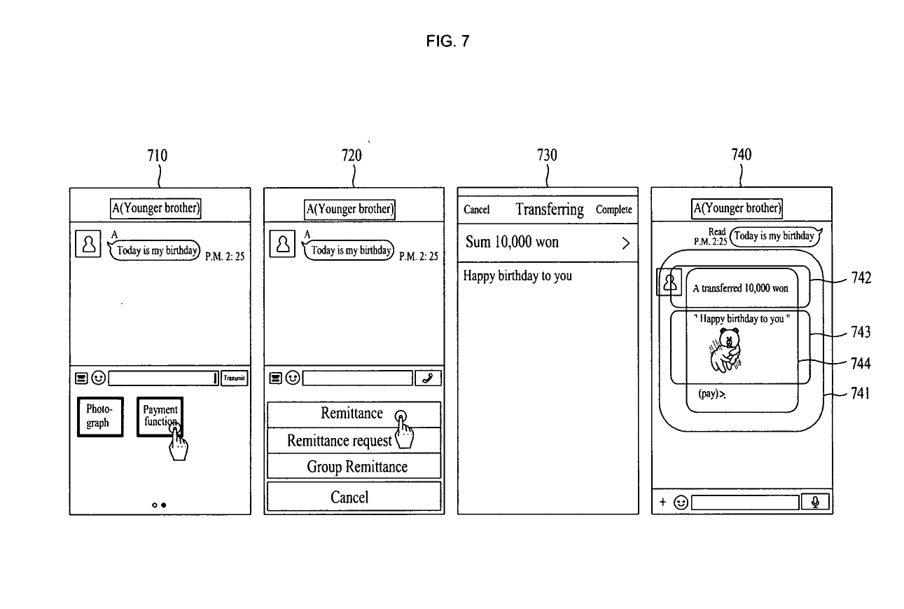

FIG. 7 illustrates screens of a user terminal when a payment transaction on remitting is executed, according to an example embodiment of the inventive concepts.

Referring to FIG. 7, as illustrated on screenshots 710-740, the payment system may remit payment in response to input provided by a user via screens 710-740.

For example, a screen 710 outputted at a terminal of ‘B’ may receive an instant message from ‘A’ and the instant message, which is “Today is my birthday”, received from terminal ‘A’ may be outputted in a chat room of an instant message application of ‘B’. ‘B’ may transfer a fund to ‘A’ to congratulate ‘A’ on a birthday of ‘A’ and select ‘Payment function’ button provided in the chat room. When ‘B’ selects ‘Payment function’ button in the chat room between ‘B’ and ‘A’, an opponent of a payment transaction may be identified as ‘A’.

Referring to a screen 720, various options may be provided in response to selecting a payment function by ‘B’. Here, ‘B’ may select a payment transaction, which he wants, from among a remittance, a remittance request, and a group-remittance. For example, ‘B’ may select ‘remittance’ of a payment transaction to transfer a fund to ‘A’.

Referring to a screen 730, ‘B’ may input 10000 won as the amount of money to be transferred from a payment account of ‘B’ to a payment account of ‘A’ as well as ‘B’ may additionally describe a message “Happy birthday” to be transmitted together with the funds.

A screen 740 may denote a screen outputted at a terminal of ‘A’. Referring to the screen 740, a transaction message 741 associated with processing a payment transaction of ‘B’ in the terminal of ‘A’.

Here, the transaction message 741 may have various attributes different from a general instant message. For example, the transaction message 741 may include a fixed format area 742, a user edit area 743, and an interaction area 744 in a speech bubble. The fixed format area 742 may be automatically generated in a fixed format in response to processing a payment transaction. Moreover, the user edit area 743 may include at least one of a text, an image, or a video, which are edited by ‘B’. Moreover, when an interaction is sensed in the interaction area 744, the payment transaction may be additionally processed based on the interaction. For example, ‘A’ may touch the interaction area 744, thereby making it possible to move a fund transferred from ‘B’ to his payment account. Further, when ‘A’ does not have a payment account, ‘A’ may touch the interaction area 744, thereby making it possible to move to a screen capable of registering a payment account. For example, one or more of screens 610-640.

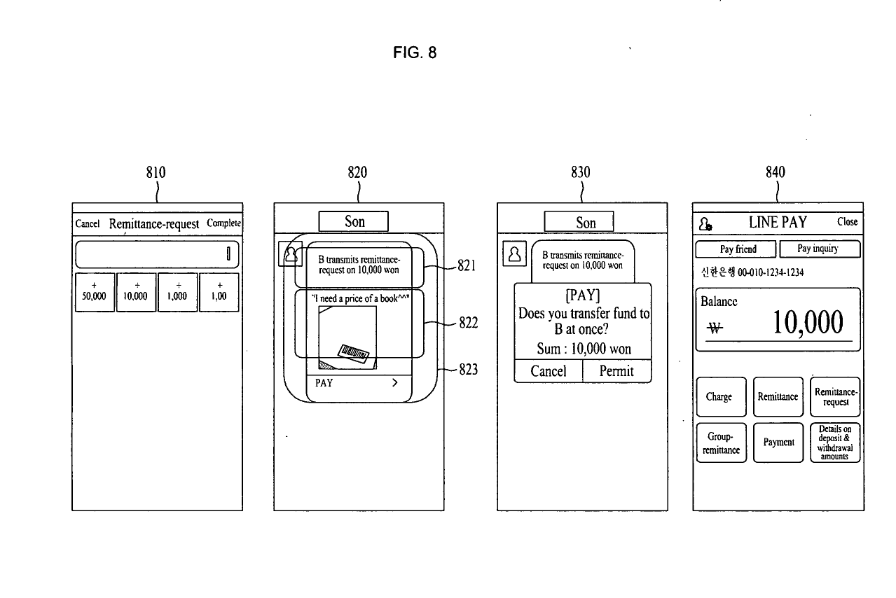

FIG. 8 illustrates screens of a user terminal when a payment transaction on remittance-requesting is executed, according to an example embodiment of the inventive concepts.

Referring to FIG. 8, as illustrated on screenshots 810-840, the payment system may facilitate a user requesting remittance of funds from an opponent in response to input provided by a user via screens 810-840.

For example, a screen 810 may denote a screen for requesting an opponent remit a specific fund for a purchase of a book by ‘B’.

As illustrated in a screen 820, when the user B transfers a transaction message (i.e., a remittance request message 823) to the opponent, a screen may be outputted through an instant message application of the opponent. Here, the transaction message (i.e., a remittance request message 823) may include a fixed format area 821 and a user edit area 822 and the fixed format area 821 may be automatically generated with a fixed format according to transmission of remittance-requesting by her son. Moreover, the user edit area 822 may include at least one of a text, an image, or a video, which are edited by the user B.

When the opponent performs an interaction with respect to the transaction message (i.e., remittance request message 821) or performs an interaction in an interaction area located under the transaction message (i.e., remittance request message 821), a screen 830 may be displayed through the opponent's terminal. Moreover, the remittance-requested amount of money included in the transaction message (i.e., remittance request message 821) may be extracted and the remittance-requested amount of money thus extracted may be automatically set. The opponent may determine whether to perform a remittance with respect to the remittance-requested amount of money, and processing of the payment transaction may be completed based on the determination.

Furthermore, in the case where the opponent does not have a payment account, a screen in which the opponent can register a payment account may be displayed if the opponent performs an interaction with respect to the transaction message (i.e., remittance request message 821) or performs an interaction in an interaction area located under the transaction message (i.e., remittance request message 821). For example, one or more of screens 610-640 may be generated by the payment system to allow the opponent to register their payment account.

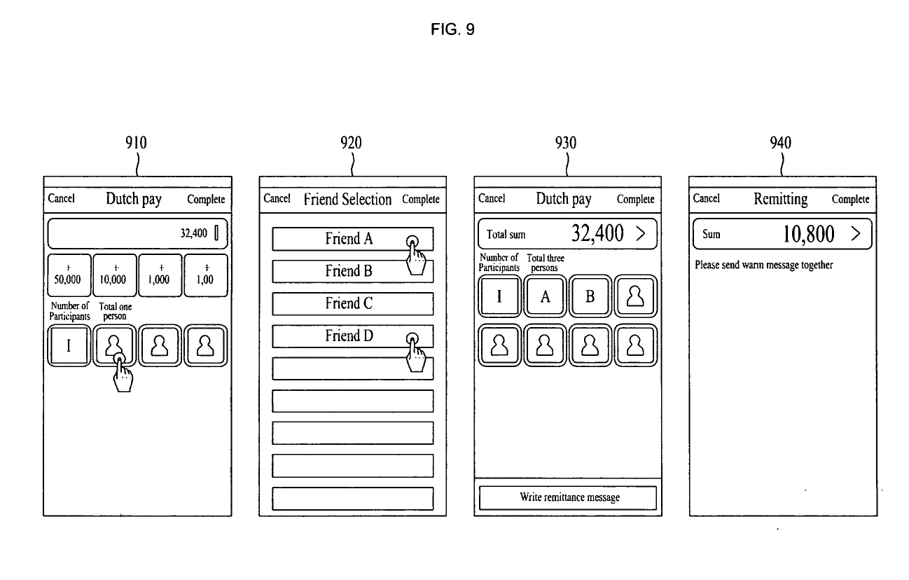

FIG. 9 illustrates screens of a user terminal when a payment transaction on a group-remitting is executed, according to an example embodiment of the inventive concepts.

Referring to FIG. 9, as illustrated on screenshots 910-940, the payment system may facilitate group remittance of payment in response to input provided by users via screens 910-940.

For example, a screen 910 may denote that a user selects group-remittance with respect to the amount of money of 32,400 won, selects members to participate in group-remittance and inputs the total amount of money.

As illustrated in a screen 920, after the user inputs a total of 32,400 won, a buddy list may be outputted to select members to be participated in group-remittance.

As illustrated in a screen 930, the user may select friends A and D as members and the user and the friends A and D may be finally determined as members to participate in a group-remittance.

As illustrated in a screen 940, the amount of money (32,400/3=10,800 won), being individually paid, of 32,400 won may be automatically calculated and each of the user and the friends A and D may transfer a share thus calculated to a third party. Here, the third party may be an online seller or an offline seller and may be any person of the user and the friends A and D.

Each of the user and the friends A and D may transfer the calculated share 10,800 won to the third party. A confirmation text on whether each of the user and the friends A and D transfers 10,800 won to the third party may be provided. For example, an instant message, which denotes whether each of the user and the friends A and D transfers 10,800 won to the third party in a chat room in which the user and the friends A and D participate, may be outputted. There may be used a graphical effect which denotes whether each of the user and the friends A and D transfers 10,800 won to the third party.

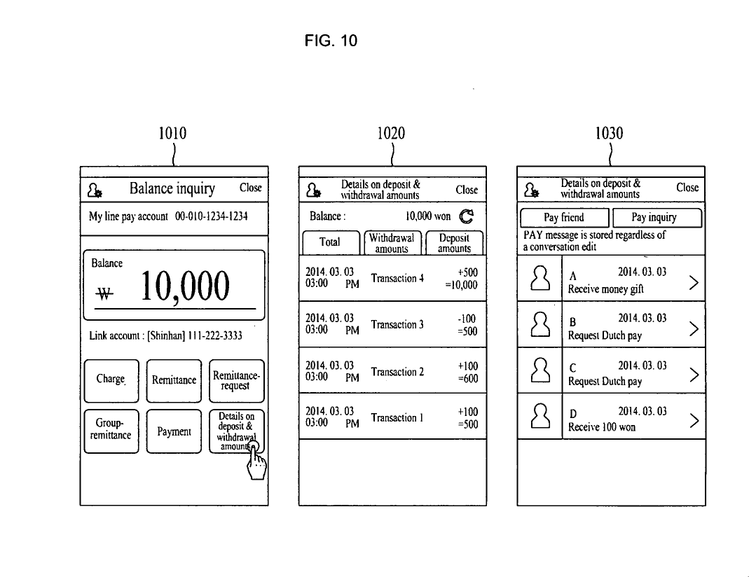

FIG. 10 illustrates screens of a user terminal after a payment transaction is completed, according to an example embodiment of the inventive concepts.

Referring to FIG. 10, as illustrated on screenshots 1010-1030, after a payment transaction is completed, the payment system confirm various information input by a user via screens 1010-1030.

For example, in a screen 1010, a user may identify details on deposit and withdrawal amounts through an instant message application with respect to a payment account. As illustrated in a screen 1020, details on all payment transactions may be provided to a user and the details may include information on an opponent of a payment transaction, information on time, information on the amount of money, and information on a transaction message.

Moreover, a user may only identify details on deposit amounts or details on withdrawal amounts.

Referring to a screen 1030, a user may identify details on a transaction with respect to each of friends of an IMS. For example, as illustrated in a screen 1030, a user may identify details on deposit and withdrawal amounts with respect to each of friends A, B, C, and D.

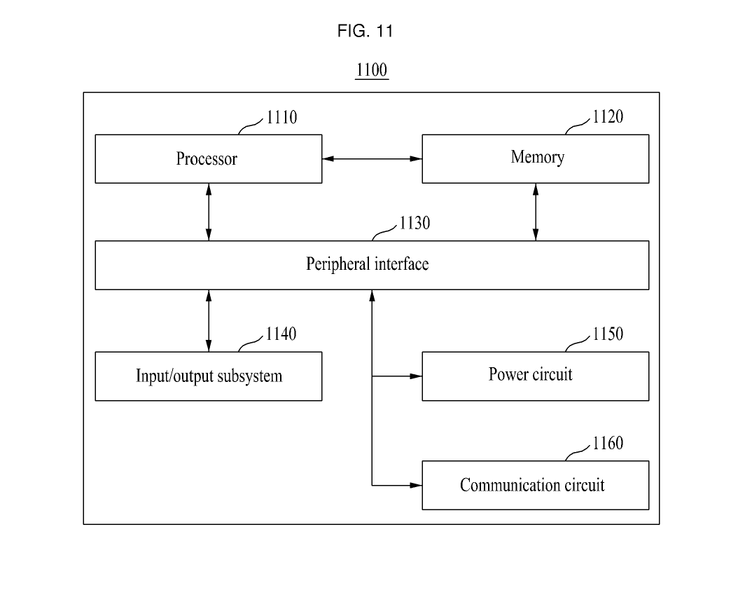

FIG. 11 is a block diagram schematically illustrating a computing device including a user terminal, an IMS server, or a payment server according to an example embodiment of the inventive concepts.

Referring to FIG. 11, a user terminal, the IMS server 140 and/or the payment server 150 described here may be implemented with a computer system 1100 according to an example embodiment of the inventive concepts. The computer system 1100 may include at least one processing device 1110, at least one memory 1120, a peripheral interface 1130, an input/output subsystem 1140, a power circuit 1150, and a communication circuit 1160.

The processing device 1110 may include one or more general-purpose or special purpose computers, such as, but not limited to a controller, an arithmetic logic unit (ALU), a digital signal processor, a microcomputer, a field programmable gate array (FPGA), a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For the sake of easy understanding, one processing device has been described; however, one skilled in the art will appreciate that the processing device may include multiple processing elements and multiple types of processing elements. For example, the processing device may include multiple processors or a processor and a controller. In addition, other processing configurations are possible, such as parallel processors.

The memory 1120 may include a high-speed random access memory (RAM), a magnetic disc, a static RAM, a dynamic RAM, a read only memory (ROM), a flash memory, or a nonvolatile memory. The memory 1120 may include a software module, a command set, or a variety of data necessary for an operation of the computer system. The processor 1120 may control an access to the memory 1120 from the processor 1110 or any other component (e.g., the peripheral interface 1130).

The peripheral interface 1130 may couple a peripheral input and/or output device of the computer system 1100 to the processor 1110 and the memory 1120. The processor 1110 may execute a software module or a command set stored at the memory 1120 to perform a variety of functions for the computer system 1100 and to process data.

The input/output subsystem 1140 may couple a variety of peripheral input/output devices to the peripheral interface 1130. For example, the input/output subsystem 1140 may include a controller for coupling a monitor, a keyboard, a mouse, a printer, or a peripheral device, such as a touch screen or a sensor, to the peripheral interface 1130. According to another aspect, peripheral input/output devices may be coupled to the peripheral interface 1130 without passing through the input/output subsystem 1140.

All or a part of components of a terminal may be powered by the power circuit 1150. For example, the power circuit 1150 may include a power management system, one or more power sources such as a battery or an alternating current (AC), a charging system, a power failure detection circuit, a power converter or inverter, a power status indicator, or any other components for power generation, management, and distribution.

The communication circuit 1160 may communicate with other computer system using at least one external port. As described above, the communication circuit 1160 may include a RF circuit and may communicate with other computer system by transmitting and receiving an RF signal known as an electromagnetic signal.

The software may include a computer program, a piece of code, an instruction, or some combination thereof, for independently or collectively instructing or configuring the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. In particular, the software and data may be stored by one or more computer readable recording mediums.

The computer system 1100 may further include components not illustrated in FIG. 11, or may be implemented such that two or more components are combined. For example, the computer system 1100 for a mobile terminal may include a touch screen, a sensor, and the like as well as components illustrated in FIG. 11, and the communication 1160 may include circuits for RF communications. Components capable of being included in the computer system 1100 may be implemented with hardware, including an integrated circuit specialized for one or more signal processing or an application, software, or a combination thereof.

The methods according to embodiments may be implemented in the format of program instruction executable through various computing devices and may be recorded in a computer-readable medium. The computer-readable medium may also include program instructions, data files, data structures, and the like independently or in the format of combination. The program instructions recorded in the medium may be those specially designed and constructed for the embodiment or may be well-known and available to those skilled in the computer software arts. Examples of the computer-readable medium may include magnetic media such as hard disks, floppy disks, and magnetic tape; optical media such as CD ROM disks and DVD; magneto-optical media such as optical disks; and hardware devices that are specialized to store and perform program instructions, such as read-only memory (ROM), random access memory (RAM), flash memory, and the like. Examples of program instructions may include both machine code produced by a compiler and high-level code executed by the computer using an interpreter. The described hardware devices may be configured to operate as one or more software modules to perform the operations of the above-described embodiments, and vice versa.

Although being described with reference to specific examples and drawings, modifications, additions and substitutions on embodiments may be variously made according to the description by those of ordinary skill in the art. For example, the described techniques may be performed in an order different with that of the methods described, and/or components such as the described system, architecture, devices, circuit, and the like, may be connected or combined to be different from the above-described methods, or results may be appropriately achieved by other components or equivalents.

Some example embodiments of the inventive concepts relate to a payment processing method and system capable of providing a payment platform combined with an IMS, thereby making it possible for users of the IMS to conveniently process a payment transaction.

Other example embodiment of the inventive concepts relate to a payment processing method and system capable of processing a user payment transaction by mapping a payment account into an account of an IMS and using the mapped account of the IMS, thereby improving compatibility between an instant message service and a payment processing service.

Other example embodiment of the inventive concepts relate to a payment processing method and system capable of outputting a message associated with processing of a payment transaction using a chat room generated through instant message application, thereby making it possible for users to conveniently identify how the payment transaction is processed.

Other example embodiment of the inventive concepts relate to a payment processing method and system capable of combining an IMS with a service for processing various payment transactions such as remitting, remittance-requesting, and group-remitting, thereby making it possible to provide a variety of options on a payment transaction to users of an IMS.

Other example embodiment of the inventive concepts relate to a provide payment processing method and system capable of specifying an opponent of a payment transaction through a chat room or a buddy list of an IMS, thereby making it possible to expand the convenience of users of an IMS.

While example embodiments of the inventive concepts have been described with reference to some example embodiments thereof, it will be apparent to those skilled in the art that various changes and modifications may be made without departing from the spirit and scope of the inventive concepts. Therefore, it should be understood that the above embodiments are not limiting, but illustrative.

What is claimed is:

1. A method of processing a payment using an instant message service (IMS), the method comprising:
obtaining information identifying a chat room associated with an instant message application, the chat room configured to facilitate a payment transaction between a first user and at least one second user;
updating a payment account of the first user and a payment account of the at least one second user in response to processing the payment transaction; and
outputting a message associated with the payment transaction through the chat room.

2. The method of claim 1, further comprising:
obtaining, from a payment account database, the payment account of the first user and the payment account of the at least one second user in response to executing the payment transaction user, and
mapping the payment account of the first user in the payment account database with an account on an IMS server.

3. The method of claim 1, wherein the updating a payment account includes,
transferring funds from the first user to the at least one second user, if the payment transaction is a remitting transaction,
requesting the first user to transfer funds to the at least one second user, if the payment transaction is a remittance-requesting transaction, and
transferring funds to a third party by a group, if the payment transaction is a group-remitting transaction, the group including the first user and the at least one second user.

4. The method of claim 1, further comprising:
identifying the second user using the information identifying the chat room, when the first user requests processing of the payment transaction in the chat room.

5. The method of claim 1, further comprising:
determining if the chat room between the first user and the at least one second user is established, in response to executing the payment transaction; and
generating a new chat room, if the determining determines that the chat room is not established.

6. The method of claim 1, wherein the chat room includes information associated with an account of the first user, an account of the at least one second user, and a unique identification number of the chat room.

7. The method of claim 1, further comprising:
displaying the message such that the displayed message includes a user edit area, and a fixed format area, the user edit area including at least one of a text, an image, or a video, provided by the first user, and the fixed format area having a format determined based on the processing of the payment transaction.

8. The method of claim 7, wherein the displaying displays the user edit area and the fixed format area in a bubble.

9. The method of claim 1, further comprising:
receiving a selection, via the chat room, the selection instructing a IMS server to perform one of a remitting transaction to transfer funds from the first user to the at least one second user, a remittance-requesting transaction to request the first user to transfer fund to the at least one second user, and a group-remitting transaction to transfer funds from a group to a third party, the group including the first user and the at least one second user.

10. The method of claim 1, further comprising:
detecting an interaction between the first user and the at least one second user via a message communicated therebetween during processing the payment transaction of the first user; and
executing processing of the payment transaction based on the interaction.

11. The method of claim 9, wherein, when the selection instructs the IMS server to perform the remittance-requesting transaction, the method further comprises:
extracting a remittance-requested amount of money included in a remittance request message transmitted from the at least one second user to the first user, and
transferring the remittance-requested amount of money from the payment account of the first user to the payment account of the at least one second user based on the remittance request message.

12. The method of claim 11, further comprising:
determining whether the payment account of the first user exists based on the remittance request message transmitted from the at least one second user to the first user.

13. The method of claim 1, wherein the message includes at least one of a value of funds remaining in the payment account of the first user after the payment transaction, a change in value of the payment account after the payment transaction, and information indicating whether the payment transaction successfully completed.

14. The method of claim 9, when the selection instructs the IMS server to perform the group-remitting transaction, the method further comprises:
selecting the at least one second user from one or more of a buddy list associated with the first user and participants associated with the chat room;
calculating a share of the funds associated with each of the first user and the at least one second user based on a number of users included in the first user and the at least one second user, and
processing a payment transaction with respect to the share associated with each of the first user and the at least one second user.

15. The method of claim 14, further comprises:
determining whether the payment transaction is executed by each of the first user and the at least one second user, and wherein
the outputting outputs the message indicating whether the payment transaction is executed.

16. A method of processing a payment on a payment platform, the payment platform configured to integrate with an instant message service (IMS), the method comprising:
receiving a request through an instant message application, the request associated with processing a payment transaction between a first user and at least one second user using information stored in a server associated with the IMS, the information indicating a relationship between the first user and the at least one second user;
extracting a first payment account corresponding to an IMS account of the first user and a second payment account corresponding to an IMS account of the at least one second user; and
updating a value registered in the first payment account and the second payment account in response to processing of the payment transaction.

17. The method of claim 16, wherein the updating comprises:
updating a value registered in the first payment account and the second payment account on the payment platform in response to processing of the payment transaction, the updating being performed without communicating with external financial institutions associated with the first user and the at least one second user.

18. The method of claim 16, wherein the extracting comprises:
obtaining, from a payment account database included in a payment server associated with the payment platform, the first payment account in response to executing the payment transaction of the first user; and
generating a map by mapping the IMS account of the first user and the IMS account of the second user with the first payment account and the second payment account, respectively, and storing the map in the payment account database.

19. The method of claim 16, wherein the payment transaction comprises:
at least one of a remitting transaction, a remittance-requesting transaction, and a group-remitting transaction, wherein
the updating transfers a fund from the first user to the at least one second user, if the payment transaction is the remitting transaction,
the updating requests the first user transfer funds to the at least one second user, if the payment transaction is the remittance-requesting transaction, and
the updating transfers a fund from a group to a third party, if the payment transaction is the group-remitting transaction, the group including the first user and the at least one second user.

20. The method of claim 19, wherein when the payment transaction is the remitting transaction, the updating comprises:
decreasing a value registered in the first payment account by an amount corresponding to a fund transmitted to the at least one second user by the first user, and
increasing a value registered in the second payment account by the amount.
